(19) United States
(12) Patent Application Publication
(10) Pub. No.: US 2012/0257296 A1
(43) Pub. Date: Oct. 11, 2012

(54) COLOR FILTER SUBSTRATE

(76) Inventors: Der-Chun WU, Taipei County (TW); Chih-Ho Lien, Taipei City (TW); Chin-Long Chen, Taipei City (TW); Shang-Chih Wu, Taoyuan County (TW)

(21) Appl. No.: 13/183,946

(22) Filed: Jul. 15, 2011

(30) Foreign Application Priority Data
Apr. 6, 2011 (TW) 100206001

(51) Int. Cl. G02B 5/22

(52) U.S. Cl. 359/891

(57) ABSTRACT

A color filter substrate includes a transparent plate, a black matrix, a plurality of filter layers, a plurality of first support pads, and a transparent conductive layer. The transparent plate has a plane. The black matrix is disposed on the plane and has a plurality of grid areas. The filter layers are disposed on the plane and located in the grid areas respectively. The first support pads partially cover the black matrix. Each of the first support pads is located among adjacent four filter layers. An area on the black matrix covered by each of the first support pads is in a shape of a cross. The first support pads are connected to the filter layers. Each first support pad includes a first pad layer, a second pad layer, and a third pad layer. The transparent conductive layer covers the filter layers, the first support pads, and the black matrix.

### CROSS-REFERENCE TO RELATED APPLICATION

This application claims the benefit of Taiwan Patent Application No. 100206001, filed on Apr. 6, 2011, which is hereby incorporated by reference for all purposes as if fully set forth herein.

### BACKGROUND OF THE INVENTION

1. Field of Invention

The present invention relates to a display component, and more particularly to a color filter substrate.

2. Related Art

In an existing method for fabricating liquid crystal displays (LCDs), a sealant is formed on a color filter substrate by using screen printing. Specifically, a screen is first placed on the color filter substrate, and an adhesive is placed on the screen. The screen has a mesh pattern, and basically the adhesive can only flow through the open areas of the mesh pattern. Next, a squeegee is used to press the screen and to force the adhesive, so that the forced adhesive flows out of the mesh pattern and is coated on the color filter substrate. Therefore, the sealant is formed.

The screen is usually woven of a plurality of metal wires, so a plurality of knots appears on a surface of the screen, and each knot is located at an intersection of two metal wires. When the squeegee presses the screen, the screen will press the color filter substrate, so the knots leave a plurality of scars on the color filter substrate. The color filter substrate has a plurality of filter layers. The more scars are formed on the filter layers, the worse the damage to the image quality of the liquid crystal display is. Even the damage can make the color filter substrate have to be reworked or scrapped.

### SUMMARY OF THE INVENTION

The present invention is directed to a color filter substrate with a plurality of support pads for supporting the screen.

The present invention provides a color filter substrate including a transparent plate, a black matrix, a plurality of filter layers, a plurality of first support pads, and a transparent conductive layer. The transparent plate has a plane. The black matrix is disposed on the plane and has a plurality of grid areas arranged in a matrix. The filter layers are disposed on the plane and located in the grid areas respectively. The color of one filter layer is different from the color of another filter layer. The first support pads are disposed on the plane and partially cover the black matrix. Each of the first support pads is located among adjacent four filter layers. An area on the black matrix covered by each of the first support pads is in a shape of a cross. The first support pads are connected to the filter layers. Each of the first support pads includes a first pad layer, a second pad layer, and a third pad layer. In the same first support pad, the second pad layer is disposed between the first pad layer and the third pad layer, and the first pad layer is disposed between the black matrix and the second pad layer. The transparent conductive layer covers the filter layers, the first support pads, and the black matrix.

Based on the above, the first support pads can support the screen, thereby decreasing the probability that a scar is formed on the filter layer and reducing the number of the scars on the filter layers.

In order to make the aforementioned features and advantages of the present invention more comprehensible, the embodiments are described in detail below with reference to the accompanying drawings.

### BRIEF DESCRIPTION OF THE DRAWINGS

The present invention will become more fully understood from the detailed description given herein below for illustration only, and thus are not limitative of the present invention, and wherein:

FIG. 1 is a schematic top view of a color filter substrate according to an embodiment of the present invention;

FIG. 2 is a schematic cross-sectional view along Line I-I in FIG. 1; and

FIG. 3 is a schematic cross-sectional view along Line J-J in FIG. 1.

### DETAILED DESCRIPTION OF THE INVENTION

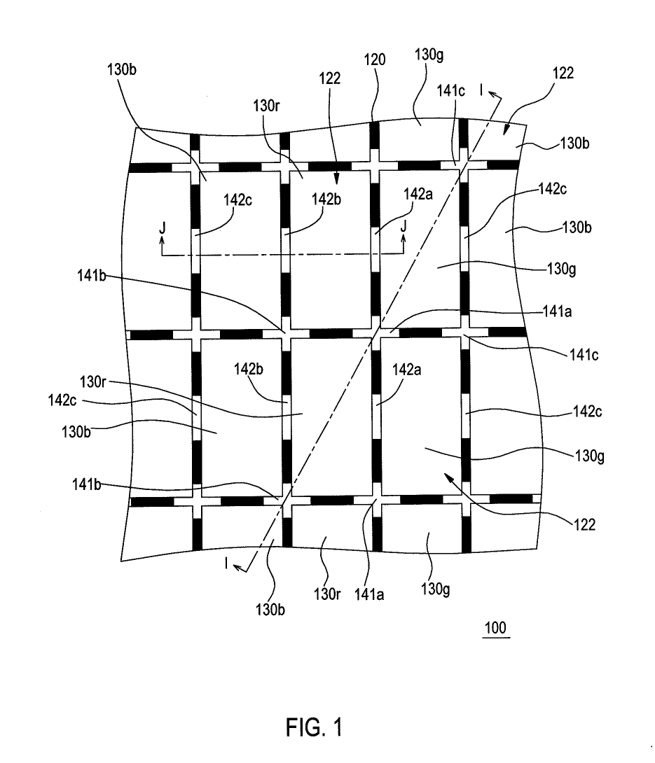

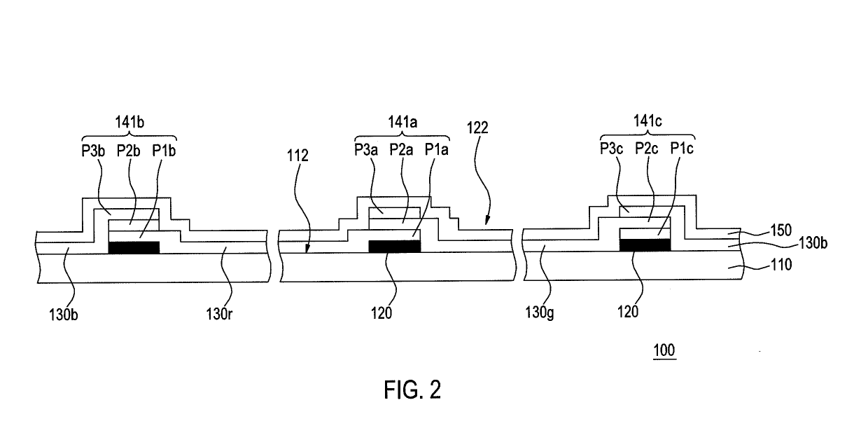

FIG. 1 is a schematic top view of a color filter substrate according to an embodiment of the present invention, and FIG. 2 is a schematic cross-sectional view along Line I-I in FIG. 1. Referring to FIG. 1 and FIG. 2, the color filter substrate 100 of this embodiment includes a transparent plate 110, a black matrix 120, a plurality of filter layers 130r, 130g, and 130b, a plurality of first support pads 141a, 141b, and 141c, and a transparent conductive layer 150.

The transparent plate 110 is, for example, a glass plate, and has a plane 112. The black matrix 120, the filter layers 130r, 130g, and 130b, and the first support pads 141a, 141b, and 141c are all disposed on the plane 112. The black matrix 120 and the filter layers 130r, 130g, and 130b are all in contact with the plane 112, and the transparent conductive layer 150 covers the filter layers 130r, 130g, and 130b, the first support pads 141a, 141b, and 141c, and the black matrix 120. The black matrix 120 is in a shape of a grid, so the black matrix 120 has a plurality of grid areas 122 arranged in a matrix. The filter layers 130r, 130g, and 130b are located in the grid areas 122 respectively.

The material for forming the filter layers 130r, 130g, and 130b may be dyed resin or dyed photoresist, and all of the filter layers 130r, 130g, and 130b do not present the same color. For example, the color of the filter layer 130r is different from the color of the filter layer 130g, the color of the filter layer 130g is different from the color of the filter layer 130b, and the color of the filter layer 130b is different from the color of the filter layer 130r, so the filter layers 130r, 130g, and 130b present three different colors respectively.

In this embodiment, the color of the filter layer 130r is red, the color of the filter layer 130g is green, and the color of the filter layer 130b is blue. However, in other embodiment, the colors of the filter layers 130r, 130g, and 130b may be other colors except red, green, and blue. For example, the color of the filter layer 130r may be yellow, the color of the filter layer 130g may be cyan, and the color of the filter layer 130b may be magenta.

The first support pads 141a, 141b, and 141c partially cover the black matrix 120. It can be seen from FIG. 1 that each area on the black matrix 120 covered by one of the first support pads 141a, one of the first support pads 141b, or one of the first support pads 141c is in a shape of a cross. The first support pads 141a, 141b, and 141c are connected to the filter layers 130r, 130g, and 130b, and each of the first support pads (that is, one of the first support pads 141a, 141b, and 141c) is located among adjacent four of the filter layers 130r, 130g, and 130b.

Taking FIG. 1 as an example, each of the first support pads 141a is located among adjacent four filter layers 130r and 130g, and connected to the four filter layers 130r and 130g. Each of the first support pads 141b is located among adjacent four filter layers 130b and 130r, and connected to the four filter layers 130b and 130r. Each of the first support pads 141c is located among adjacent four filter layers 130g and 130b, and connected to the four filter layers 130g and 130b.

In this embodiment, each of the first support pads 141a, 141b, and 141c may include a plurality of layers. Taking FIG. 2 as an example, each of the first support pads 141a includes a first pad layer P1a, a second pad layer P2a, and a third pad layer P3a. Each of the first support pads 141b includes a first pad layer P1b, a second pad layer P2b, and a third pad layer P3b. Each of the first support pads 141c includes a first pad layer P1c, a second pad layer P2c, and a third pad layer P3c.

In the same first support pad 141a, the second pad layer P2a is disposed between the first pad layer P1a and the third pad layer P3a, and the first pad layer P1a is disposed between the black matrix 120 and the second pad layer P2a. The first pad layer P1a and the second pad layer P2a in the same first support pad 141a may be connected to the filter layer 130r and the filter layer 130g respectively, and the third pad layer P3a may not be connected to any filter layers 130r, 130g, and 130b. In addition, the adjacent two filter layers 130r may be connected to one of the first pad layers P1a, and the other adjacent two filter layers 130g may be connected to one of the second pad layers P2a.

Additionally, both the first pad layer P1a and the filter layer 130r may be formed of one photoresist layer developed, and both the second pad layer P2b and the filter layer 130g may be formed of another photoresist layer developed, so that the materials for forming the first pad layer P1a and the filter layer 130r may be the same, and the materials for forming the second pad layer P2b and the filter layer 130g may be the same. Although the third pad layer P3a may not be connected to any filter layers 130r, 130g, and 130b, both the third pad layer P3a and the filter layer 130b may be formed of one photoresist layer developed, so that the materials for forming the third pad layer P3a and the filter layer 130b may be the same.

It is similar to the first support pad 141a that in the same first support pad 141b, the second pad layer P2b is disposed between the first pad layer P1b and the third pad layer P3b, and the first pad layer P1b is disposed between the black matrix 120 and the second pad layer P2b. The first pad layer P1b and the third pad layer P3b in the same first support pad 141b may be connected to the filter layer 130r and the filter layer 130b respectively, and the second pad layer P2b may not be connected to any filter layers 130r, 130g, and 130b. In addition, the adjacent two filter layers 130r may be connected to one of the first pad layers P1b, and the other adjacent two filter layers 130b may be connected to one of the third pad layers P3b.

Both the first pad layer P1b and the filter layer 130r may be formed of one photoresist layer developed, and both the third pad layer P3b and the filter layer 130b may be formed of another photoresist layer developed, so that the materials for forming the first pad layer P1b and the filter layer 130r may be the same, and the materials for forming the third pad layer P3b and the filter layer 130b may be the same. Although the second pad layer P2b may not be connected to any filter layers 130r, 130g, and 130b, both the second pad layer P2b and the filter layer 130g may be formed of one photoresist layer developed, so that the materials for forming the second pad layer P2b and the filter layer 130g may be the same.

It is also similar to the first support pad 141a that in the same first support pad 141c, the second pad layer P2c is disposed between the first pad layer P1c and the third pad layer P3c, and the first pad layer P1c is disposed between the black matrix 120 and the second pad layer P2c. The second pad layer P2c and the third pad layer P3c in the same first support pad 141c may be connected to the filter layer 130g and the filter layer 130b respectively, and the first pad layer P1c may not be connected to any filter layers 130r, 130g, and 130b. In addition, the adjacent two filter layers 130g may be connected to one of the second pad layers P2c, and the other adjacent two filter layers 130b may be connected to one of the third pad layers P3c.

Both the second pad layer P2c and the filter layer 130g may be formed of one photoresist layer developed, and both the third pad layer P3c and the filter layer 130b may be formed of another photoresist layer developed, so that the materials for forming the second pad layer P2c and the filter layer 130g may be the same, and the materials for forming the third pad layer P3c and the filter layer 130b may be the same. Although the first pad layer P1c may not be connected to any filter layers 130r, 130g, and 130b, both the first pad layer P1c and the filter layer 130r may be formed of one photoresist layer developed, so that the materials for forming the first pad layer P1c and the filter layer 130r may be the same.

Based on the above, in the process of forming the sealant by using the screen printing, the first support pads 141a, 141b, and 141c can support the screen, thereby decreasing the probability that a scar is formed on the filter layer 130r, 130g, or 130b and reducing the number of the scars on the filter layers 130r, 130g, and 130b. Therefore, not only the damage to the display image quality caused by the scars can be mitigated, but also the probability that the color filter substrate 100 needs to be reworked or scrapped is decreased, thereby reducing the fabrication cost.

It is noted that in the embodiment shown in FIG. 1, a first support pad 141a, 141b, or 141c is disposed among adjacent four of the filter layers 130r, 130g, and 130b, but in other embodiment, it is not necessary to dispose a first support pad 141a, 141b, or 141c among every adjacent four of the filter layers 130r, 130g, and 130b.

Taking FIG. 1 as an example, the color filter substrate 100 may include the first support pads 141a and 141b, but does not include any first support pads 141c. Alternatively, the color filter substrate 100 may also include only the first support pads 141c, but does not include any first support pads 141a or 141b. Therefore, the number and the distribution of the first support pads 141a, 141b, and 141c as shown in FIG. 1 are only exemplary, and do not limit the present invention.

Additionally, in this embodiment, the color filter substrate 100 may further include a plurality of second support pads 142a, 142b, and 142c. The second support pads 142a, 142b, and 142c are all disposed on the plane 112 and partially cover the black matrix 120. As seen from FIG. 1, an areas on the black matrix 120 covered by each of the second support pads 142a, each of the second support pads 142b, or each of the second support pads 142c is in a shape of “1”.

The second support pads 142a, 142b, and 142c are connected to the filter layers 130r, 130g, and 130b, and each of the second support pads (that is, one of the second support pads 142a, 142b, and 142c) is located between adjacent two of the filter layers 130r, 130g, and 130b, and between two of the first support pads 141a, 141b, and 141c, as shown in FIG. 1.

Taking FIG. 1 as an example, each of the second support pads 142a is located between the adjacent filter layers 130r and 130g and is connected to the two filter layers 130r and 130g. Each of the second support pads 142b is located between the adjacent filter layers 130b and 130r and is connects to the two filter layers 130b and 130r. Each of the second support pads 142c is located between the adjacent filter layers 130g and 130b and is connect to the two filter layers 130g and 130b.

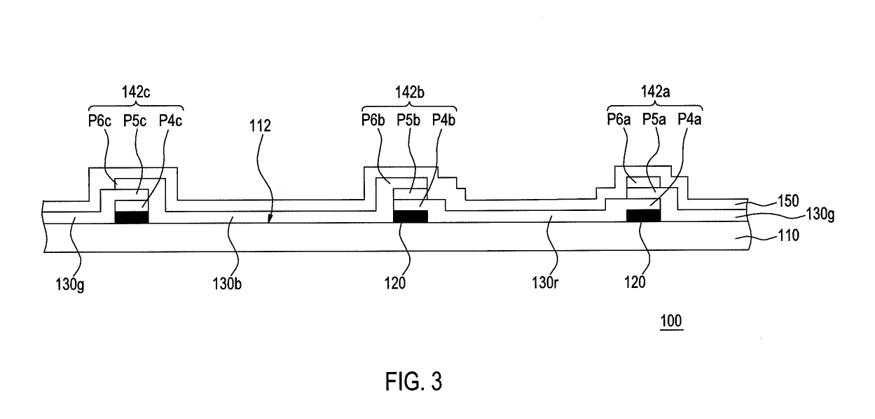

FIG. 3 is a schematic cross-sectional view along Line J-J in FIG. 1. Referring to FIG. 1 and FIG. 3, in this embodiment, each of the second support pads 142a, 142b, and 142c may include a plurality of layers. Taking FIG. 3 as an example, each of the second support pads 142a includes a fourth pad layer P4a, a fifth pad layer P5a, and a sixth pad layer P6a. Each of the second support pads 142b includes a fourth pad layer P4b, a fifth pad layer P5b, and a sixth pad layer P6b. Each of the second support pads 142c includes a fourth pad layer P4c, a fifth pad layer P5c, and a sixth pad layer P6c.

In the same second support pad 142a, the fifth pad layer P5a is disposed between the fourth pad layer P4a and the sixth pad layer P6a, and the fourth pad layer P4a is disposed between the black matrix 120 and the fifth pad layer P5a. The fourth pad layer P4a and the fifth pad layer P5a in the same second support pad 142a may be connected to the filter layer 130r and the filter layer 130g respectively, and the sixth pad layer P6a may not be connected to any filter layers 130r, 130g, and 130b.

Both the fourth pad layer P4a and the filter layer 130r may be formed of one photoresist layer developed, and both the fifth pad layer P5a and the filter layer 130g may be formed of another photoresist layer developed, so that the materials for forming the fourth pad layer P4a and the filter layer 130r may be the same, and the materials for forming the fifth pad layer P5a and the filter layer 130g may be the same. Although the sixth pad layer P6a may not be connected to any filter layers 130r, 130g, and 130b, both the sixth pad layer P6a and the filter layer 130b may be formed of one photoresist layer developed, so that the materials for forming the sixth pad layer P6a and the filter layer 130b may be the same.

It is similar to the second support pad 142a that in the same second support pad 142b, the fifth pad layer P5b is disposed between the fourth pad layer P4b and the sixth pad layer P6b, and the fourth pad layer P4b is disposed between the black matrix 120 and the fifth pad layer P5b. The fourth pad layer P4b and the sixth pad layer P6b in the same second support pad 142b may be connected to the filter layer 130r and the filter layer 130b respectively, and the fifth pad layer P5b may not be connected to any filter layers 130r, 130g, and 130b.

Both the fourth pad layer P4b and the filter layer 130r may be formed of one photoresist layer developed, and both the sixth pad layer P6b and the filter layer 130b may be formed of another photoresist layer developed, so that the materials for forming the fourth pad layer P4b and the filter layer 130r may be the same, and the materials for forming the sixth pad layer P6b and the filter layer 130b may be the same. Although the fifth pad layer P5b may not be connected to any filter layers 130r, 130g, and 130b, both the fifth pad layer P5b and the filter layer 130g may be formed of one photoresist layer developed, so that the materials for forming the fifth pad layer P5b and the filter layer 130g may be the same.

It is also similar to the second support pad 142a that in the same second support pad 142c, the fifth pad layer P5c is disposed between the fourth pad layer P4c and the sixth pad layer P6c, and the fourth pad layer P4c is disposed between the black matrix 120 and the fifth pad layer P5c. The fifth pad layer P5c and the sixth pad layer P6c in the same second support pad 142c may be connected to the filter layer 130g and the filter layer 130b respectively, and the fourth pad layer P4c may not be connected to any filter layers 130r, 130g, and 130b.

Both the fifth pad layer P5c and the filter layer 130g may be formed of one photoresist layer developed, and both the sixth pad layer P6c and the filter layer 130b may be formed of another photoresist layer developed, so that the materials for forming the fifth pad layer P5c and the filter layer 130g may be the same, and the materials for forming the sixth pad layer P6c and the filter layer 130b may be the same. Although the fourth pad layer P4c may not be connected to any filter layers 130r, 130g, and 130b, both the fourth pad layer P4c and the filter layer 130r may be formed of one photoresist layer developed, so that the materials for forming the fourth pad layer P4c and the filter layer 130r may be the same.

The functions of the second support pads 142a, 142b, and 142c are all the same as those of the first support pads 141a, 141b, and 141c, so in the process of forming the sealant by using the screen printing, the second support pads 142a, 142b, and 142c can also support the screen, thereby decreasing the probability that a scar is formed on the filter layer 130r, 130g, or 130b and effectively reducing the number of the scars on the filter layers 130r, 130g, and 130b. Therefore, the probability that the color filter substrate 100 needs to be reworked or scrapped is further decreased, and the fabrication cost is able to be reduced.

However, it should be noted that in other embodiment, the color filter substrate 100 may not include any second support pads 142a, 142b, and 142c. That is to say, the second support pads 142a, 142b, and 142c are all optional components of the color filter substrate 100, rather than essential components. Therefore, the second support pads 142a, 142b, and 142c as shown in FIG. 1 and FIG. 3 are only exemplary, and do not limit the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A color filter substrate, comprising:
a transparent plate, having a plane;
a black matrix, disposed on the plane and having a plurality of grid areas arranged in a matrix;
a plurality of filter layers, disposed on the plane and located in the grid areas respectively, wherein the color of one filter layer is different from the color of another filter layer;
a plurality of first support pads, disposed on the plane and partially covering the black matrix, wherein each of the first support pads is located among adjacent four filter layers, an area on the black matrix covered by each of the first support pads is in a shape of a cross, the first support pads are connected to the filter layers, each of the first support pads comprises a first pad layer, a second pad layer, and a third pad layer, and in the same first support pad, the second pad layer is disposed between the first pad layer and the third pad layer, and the first pad layer is disposed between the black matrix and the second pad layer; and
a transparent conductive layer, covering the filter layers, the first support pads, and the black matrix.

2. The color filter substrate according to claim 1, wherein the first pad layer and the second pad layer in one of the first support pads are connected to two of the filter layers respectively.

3. The color filter substrate according to claim 1, wherein adjacent two filter layers are connected to one of the first pad layers, and the other adjacent two filter layers are connected to one of the second pad layers.

4. The color filter substrate according to claim 1, wherein the second pad layer and the third pad layer in one of the first support pads are connected to two of the filter layers respectively.

5. The color filter substrate according to claim 1, wherein adjacent two filter layers are connected to one of the second pad layers, and the other adjacent two filter layers are connected to one of the third pad layers.

6. The color filter substrate according to claim 1, wherein the third pad layer and the first pad layer in one of the first support pads are connected to two of the filter layers respectively.

7. The color filter substrate according to claim 1, wherein adjacent two filter layers are connected to one of the third pad layers, and the other adjacent two filter layers are connected to one of the first pad layers.

8. The color filter substrate according to claim 1, further comprising a plurality of second support pads disposed on the plane, wherein each of the second support pads partially covers the black matrix and is located between adjacent two filter layers and between two of the first support pads.

9. The color filter substrate according to claim 8, wherein each of the second support pads comprises a fourth pad layer, a fifth pad layer, and a sixth pad layer, and in the same second support pad, the fifth pad layer is disposed between the fourth pad layer and the sixth pad layer, and the fourth pad layer is disposed between the black matrix and the fifth pad layer.

10. The color filter substrate according to claim 9, wherein the fourth pad layer and the fifth pad layer in one of the second support pads are connected to two of the filter layers respectively.

11. The color filter substrate according to claim 9, wherein the fifth pad layer and the sixth pad layer in one of the second support pads are connected to two of the filter layers respectively.

12. The color filter substrate according to claim 9, wherein the sixth pad layer and the fourth pad layer in one of the second support pads are connected to two of the filter layers respectively.
